(19) United States
(12) Patent Application Publication
(10) Pub. No.: US 2010/0063894 A1
(43) Pub. Date: Mar. 11, 2010

(54) BRICK AND MORTAR PLUS "VIRTUAL" STORE

(75) Inventor: Rene R. Lundy, Bend, OR (US)

Correspondence Address: PEDERSEN & COMPANY, PLLC, P.O. BOX 2666, BOISE, ID, 83701, US

(73) Assignee: BELLATRIX SYSTEMS, INC., Bend, OR (US)

(21) Appl. No.: 12/555,797

(22) Filed: Sep. 8, 2009

Related U.S. Application Data
(60) Provisional application No. 61/094,603, filed on Sep. 5, 2008.

(51) Int. Cl. G06Q 30/00; G06Q 50/00

(52) U.S. Cl. 705/26

(57) ABSTRACT

The present invention recognizes that in sales and deliveries of large digital content such as movies, the volume of sales is best affected by wide area, low speed connections for browsing and comparison shopping, while customer satisfaction is best served by high speed wired connections where chosen and purchased content can be delivered relatively quickly. This can occur in a physical area where customers are in close proximity to the vending kiosk, or will be in close proximity at a later time, such as when shopping near the kiosk. At the kiosk, high speed wired connections make the quick delivery. By creating such a configuration, sales are maximized and the customer experience is enhanced.

This application claims priority from U.S. Provisional Application 61/094,603, filed Sep. 5, 2008, which is incorporated herein by reference.

### BACKGROUND OF THE INVENTION

1. Field of the Invention

This invention relates generally to retail services. More specifically, this invention relates to a retail store method and system for shopping and purchasing items of relatively large digital content, such as movies.

2. Related Art

Consumers desire to receive and experience multimedia content on their personal computerized portable devices. These media are conversions or elemental sources including but not limited to newspapers, magazines, books, music and movies. These portable devices include but are not limited to laptop computers, PDA's, smart phones and portable Internet devices. A variety of providers have already been established to deliver that content. However, several challenges still restrict wide acceptance of a convenient way to purchase, deliver, and receive the content. The challenges include:
Hard digital media sources such as DVDs must be borrowed or purchased. If borrowed, the consumer must track the whereabouts of the content and/or return it at the provider's location in a timely manner. If purchased, the buyer must spend more money than if borrowed and then find room to store the content in a physical location. Further, stores or dispensers are physically limited in the number of items for rent or sale; and,
Soft digital media sources deliver content in a purely digital form. A common pipeline for delivery of this content is the Internet. However, the size of the content can mean long download waits while the content is delivered to the user's PC. Further, physical advertising for the source for the content is almost always physically removed from the Internet access, making discovery of the content more arduous or chancy. Further, connection fees are often imposed by the providers of the internet access, effectively increasing the price of the delivered content.

In addition, both hard and soft media deliveries when automated often restrict the numbers of shoppers. That is to say, at a typical kiosk when one person is buying, others are restricted from browsing, operating or buying.

### SUMMARY OF THE INVENTION

A retail store method and system for selling soft digital media is described. It contains two elements:
The first element is a browsing environment where shoppers can look at merchandise. This environment may be virtual in that it exists as wireless or wired information available to both portable and fixed computing devices. The virtual environment may be accessed by relatively slow connections, as it does not deliver large volumes of content; and,
The second element is a physical location containing one or more physical high speed connections, such a kiosk or area of kiosks. These connections operate at a much higher relative speed, relative to the browsing environment connections, to deliver media content in a timely manner. A customer attaches its portable computing device or memory device to these connections in order to receive content. The aspects of the two elements of the store are such that the shopping and buying experience mimic those of physical stores: Many shoppers may browse at the same time remote from the kiosks, while a few shoppers may conclude purchases quickly at the kiosks.

### BRIEF DESCRIPTION OF THE DRAWINGS

FIG. 1 is a schematic depiction of one embodiment of the first browsing environment of the present invention.

FIG. 2 is a schematic depiction of one embodiment of the second buying environment of the present invention.

FIG. 3 is a schematic depiction of one embodiment of the present invention wherein the first browsing environment and the second browsing environment are in close physical proximity.

### DETAILED DESCRIPTION OF THE INVENTION

### The Browsing Environment

Browsing selections may be made available remotely from the store and its purchasing kiosks over a number of existing and still to be developed mediums such as the internet, cell phone networks, cable systems or closed networks within malls, etc. Browsing may be accomplished by digital computing devices both portable and fixed. However, purchasing and media downloads are typically accomplished by physical travel of the customers to the store's physical purchasing environment.

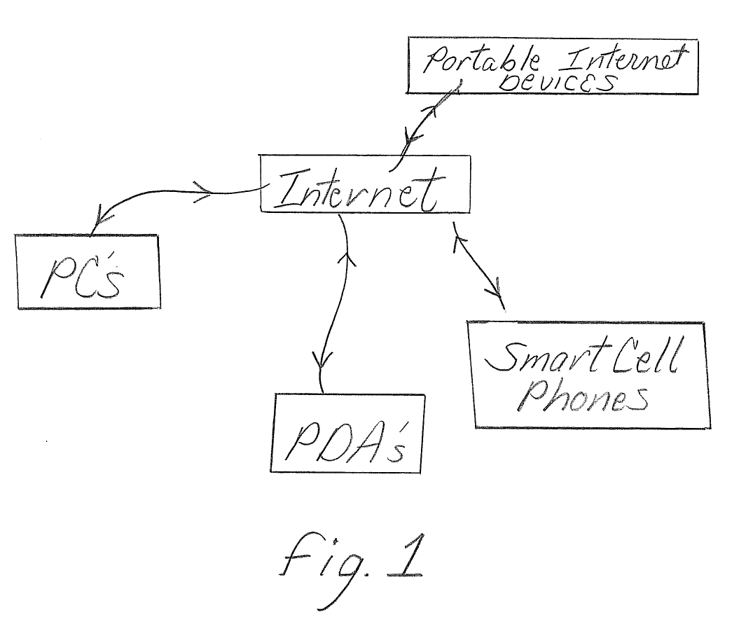

In FIG. 1, for example, there is schematically depicted one embodiment of the browsing environment. In this embodiment, the browsing environment is the Internet, and two-way connections to it from, for example, PC's, PDA's, smart cell phones and/or portable Internet devices, etc. This Internet embodiment is a “virtual” browsing environment. However, the browsing environment of the present invention may also exist in other embodiments. For example, print media ads in newspapers, magazines and catalogs may also effectively provide the browsing environment of the present invention. Over time, even reputation or word-of-mouth may provide the browsing environment, as the public becomes more familiar with the invention.

Access to these print media items for the browsing environment is considered via “relatively slow connections” because they must be printed first and then physically delivered to shoppers, a slow process compared to presenting the information directly to shoppers at hand-wired speeds. For example, current WiFi connections to the Internet run at about 22 megabits per second (MB/sec.), and are expected to increase soon to about 140 MB/sec. Current USB connections, on the other hand, run at about 480 MB/sec., more than an order of magnitude faster than WiFi. Soon, future hard-wired speeds via the Internet are expected to increase to about 1000 MB/sec., still about an order of magnitude difference, compared to the wireless speeds. Therefore, one skilled in the art of digital transmission will continue to be able to clearly differentiate between the wireless speed for the browsing environment discussed above and the wired speeds for the purchasing environment discussed below.

### The Purchasing Environment

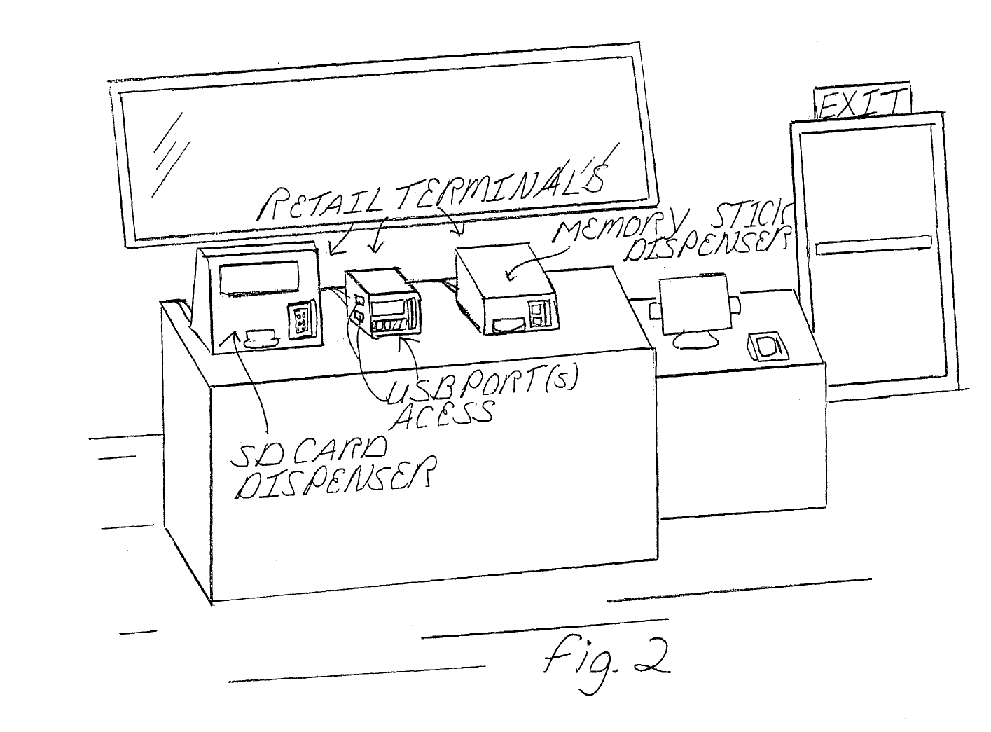

In FIG. 2, for example, there is schematically depicted one embodiment of the purchasing environment of the present invention. In this embodiment, the purchasing environment is a retail sales counter with sales terminals. One sales terminal is a memory stick dispenser. At this dispenser, for example, the customer arrives after having ordered a selection of media from the browsing environment. The ordering would entail, for example, a customer and transaction identification correlated to a selection from the media library presented to the purchaser in the browsing environment. Also, during the ordering, the customer would indicate a choice for receiving the downloaded media content—either digitally via a USB port, for example, directly to the customer's PC, PDA, etc., or stored in a memory stick or a memory card (for example, an SD card). This way, the ordered, downloaded content is ready to be transferred to the purchaser immediately upon the purchaser's arrival at the purchasing environment.

If the purchaser has earlier selected a USB port transfer, then, upon verification of the customer and transaction identification, the USB terminal is activated to make the media content available at the USB port. The purchaser simply plugs its portable device into the activated USB port, and receives the media content at USB speed.

Alternatively, if the purchaser has earlier selected a memory stick or an SD card transfer, then, upon verification of the customer and transaction identification at the sales counter, the memory stick dispenser or the SD card dispenser, whichever was pre-selected by the purchaser, is activated. In one embodiment of this type of transfer, a new memory stick or SD card, loaded with the pre-selected content, is dispensed to the customer. The customer may be given credit for returning an old memory stick or SD card at this time.

### The Combined Browsing and Purchasing Environment

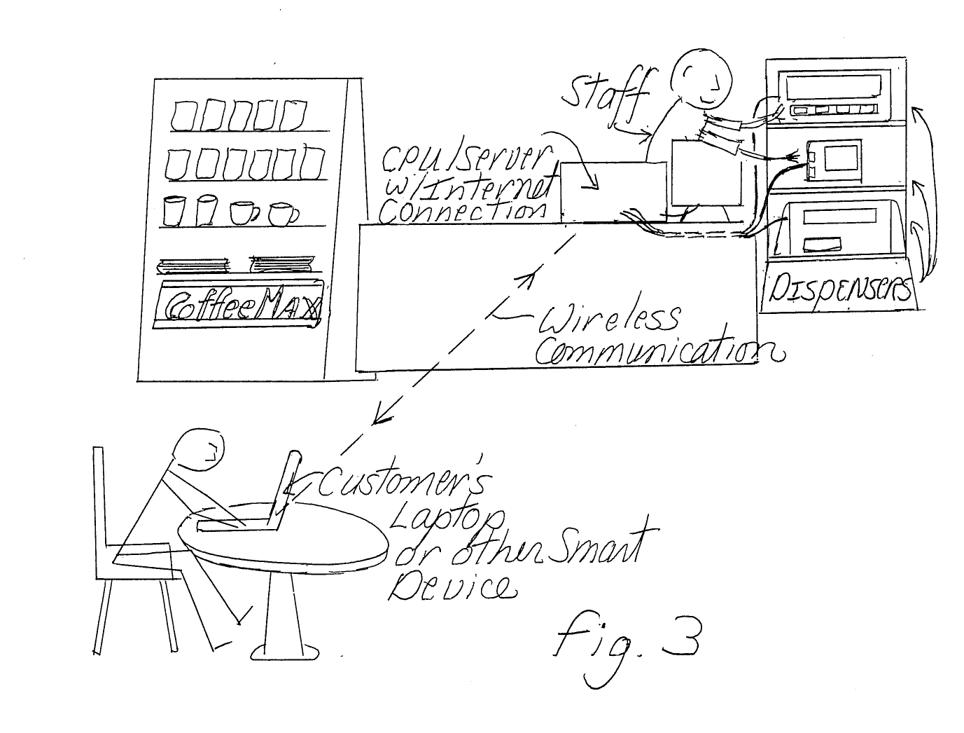

In FIG. 3, for example, there is schematically depicted one embodiment of the combined browsing and purchasing environment. In this embodiment, the browsing environment is in close physical proximity to the purchasing environment. One example of this combined browsing and purchasing environment is a retail setting in the form of a coffee shop store.

Media is advertised in the physical area of the store. The in-store advertisements are local to the high speed connections to entice purchases at the sales counters, which are also in the store. Therefore, for the combined browsing and purchasing environment, the two environments are in relatively close physical proximity. This means they are within about local WiFi range according to current (2009) technology. This range may increase with future technology, but it is expected to remain less than worldwide, as encompassed now by Internet technology. Therefore, “physically remote” for this invention means physically further away than the range of a WiFi connection.

A local free wireless and/or wired network provides shoppers in the physical environment with the ability to browse and select their purchases. This network allows shoppers to use computerized portable devices to view the available inventory of digital content over wired or wireless connections within the defined physical area. The free network area is defined by the wireless or wired communication limits. Provision is made for a number of simultaneous shoppers to browse the inventory at once.

Provision is made for a number of physical high speed connections at the physical store. These high speed data connections provide for download of the purchased product, for example, into the customer's portable computing or memory device. Since the content is soft digital, the number of copies of each product is unlimited and the number of different products can be large. Since the physical local connections deliver data at a much higher rate than other alternatives, the buying experience is optimized in terms of promptness and convenience.

A method of coordination such as a credit card number is available to match the delivery of content to the correct purchaser. For example, after selections are made in the virtual store, the buyer enters the last four digits of their credit card with the order. Upon arriving at the high speed connection in the physical store, the credit card is swiped and the order matching the numbers is made available.

The use of a credit card or other substantiation is utilized to restrict access to the high speed ports or physical areas of the store needed for paying customers. For example, a mechanical release opens a shelf exposing a high speed cable when a buyer's credit card is swiped through a reader.

### One Typical Scenario:

A kiosk is established in an airport. Movie and magazine soft media has been loaded into a computer in the kiosk. A large screen shows previews of movies and magazines available.

Travelers wishing to read magazines and watch movies on their trip sit in seats near the kiosk and establish a WiFi connection with the kiosk's free local wireless network. They use their standard internet browser, but have access to only one site. That site displays the selections available from the kiosk.

Alternatively, travelers browse the internet at home before departing to the airport and select the desired entertainment.

Browsers look at previews or titles at their leisure, selecting those they wish to purchase. When they are finished browsing they enter a number from their credit card.

The buyer then proceeds to the kiosk itself. There it swipes the same credit card, which opens a shelf and exposes a USB cable. The buyer then plugs the USB cable into the PC. The movies and magazines are loaded automatically into the buyer's laptop at very high speed.

Alternatively, the buyer plugs its memory stick into the USB cable, or interacts with a memory stick or SD card dispenser as discussed above. The movies and magazines are loaded automatically into the memory stick or SD card at very high speed.

The buyer's credit card is charged, and it leaves.

According to the current practice, before adoption of the present invention, using portable memory devices such as flash drives to download video media can take up to 3 or 4 minutes per film. This means long wait times for customers. To solve this dilemma, I propose as an alternative embodiment using a media “vault”. The vault is a location on the soft media kiosk where a customer can plug their portable media in and have it protected from access until the original customer returns. In this way a customer is free to leave the immediate vicinity of the kiosk for shopping or other activities, returning when convenient.

For example, a shopper selects a movie at home on the PC, then travels to the grocery store soft media kiosk to pick up their movie. The shopper swipes the same credit card used at home. The kiosk then lists a number on the local screen corresponding to one of a number of rectangular openings (vaults) in the front of the kiosk. The customer plugs its flash drive into a connector in the opening and presses an “OK” button on the kiosk. In response, the kiosk slides a door down, closing the media vault and starting a countdown on the screen. The countdown tells the customer when the download will complete. The customer is now free to shop in the grocery store. After shopping, the customer retrieves its media drive with the movie downloaded on it by swiping its credit card a final time. This swipe opens the kiosk vault door.

Although this invention has been described above with reference to particular means, materials and embodiments, it is to be understood that the invention is not limited to these disclosed particulars, but extends instead to all equivalents within the broad scope of the following claims.

I claim:

1. A method for vending digital content, which comprises:
providing a browsing environment wherein potential purchasers can view digital content available for vending, the browsing environment being made available to the potential purchasers via a relatively slow connection;
providing a purchasing environment wherein potential purchasers can purchase the digital content, the purchase being made available via a relatively fast connection, relative to the browsing environment connection.

2. The method of claim 1, wherein:
the browsing environment is physically remote from the purchasing environment.

3. The method of claim 1, wherein:
the browsing environment is in physical proximity to the purchasing environment.

4. The method of claim 1, wherein:
the vended digital content is digitally delivered to the purchaser's portable digital device.

5. The method of claim 1, wherein:
the vended digital content is delivered to the purchaser in a memory stick or a memory card.

6. The method of claim 1, wherein:
the browsing environment connection is the Internet.

7. The method of claim 1, wherein:
the browsing environment connection is print media.

8. The method of claim 1, wherein:
the browsing environment connection is reputation or word-of-mouth.

9. A system for vending digital content, which comprises:
a browsing environment wherein potential purchasers can view digital content available for vending, the browsing environment being present in a relatively slow connection; and,
a purchasing environment being present in a relatively fast connection, relative to the browsing environment, wherein purchasers can purchase the digital content.

10. The system of claim 9, wherein:
the browsing environment is physically remote from the purchasing environment.

11. The system of claim 9, wherein:
the browsing environment is in physical proximity to the purchasing environment.

12. The system of claim 9, wherein:
the vended digital content is digitally delivered to the purchaser's portable digital device.

13. The system of claim 9, wherein:
the vended digital content is delivered to the purchaser in a memory stick or a memory card.

14. The system of claim 9, wherein:
the browsing environment connection is the Internet.

15. The system of claim 9, wherein:
the browsing environment connection is print media.

16. The system of claim 9, wherein:
the browsing environment connection is reputation or word-of-mouth.
